(19) United States
(12) Patent Application Publication
(10) Pub. No.: US 2020/0148451 A1
(43) Pub. Date: May 14, 2020

(54) FOLDING JEWELRY WARMER

(71) Applicant: Brr Less Limited, Arvada, CO (US)

(72) Inventors: Adam Sweetser, Arvada, CO (US); Anna Bruce, Arvada, CO (US)

(21) Appl. No.: 16/678,147

(22) Filed: Nov. 8, 2019

Related U.S. Application Data
(60) Provisional application No. 62/758,082, filed on Nov. 9, 2018.

(51) Int. Cl. B65D 81/34; A45C 11/16; H05B 3/34

(52) U.S. Cl. CPC B65D 81/3476; H05B 3/342; A45C 11/16

(57) ABSTRACT

A device for warming jewelry includes a body structure forming a pouch for receiving the jewelry on a soft surface of the body. At least one flap of the body structure folds over the jewelry in a closed position of the pouch. A heating element inside the body structure is activated to warm the jewelry within the body structure. The body structure may have a single flap configuration or a dual or multi-flap configuration.

### PRIORITY CLAIM

This application claims the priority benefit of U.S. Provisional Patent Application No. 62/758,082 filed Nov. 9, 2018 for “Folding Jewelry Warmer” of Adam Sweetser and Anna Bruce, hereby incorporated by reference in its entirety as though fully set forth herein.

### BACKGROUND

Cold jewelry can be uncomfortable to put on when it is cold. Building internal temperatures are typically cooler than the human body, and during the winter, indoor and outdoor temperatures tend to be colder, while the human body stays at a relatively consistent temperature. For example, if the interior temperature of a building is sixty-seven degrees, then most objects in the building will also be at sixty-seven degrees, including jewelry. In this example, when a person goes to put on a necklace, there could be a thirty degree difference in temperature between the necklace and the wearer's body. In such cases, as soon as the jewelry touches the skin, it may feel uncomfortably cold. People have held the jewelry in their hands, placed in pockets, or used hair dryers to heat up the jewelry before donning it.

### BRIEF DESCRIPTION OF THE DRAWINGS

FIG. 1 shows the inside of a flap configuration of the example folding jewelry warmer, in an unzipped or open position.

FIG. 2 shows the outside of a flap configuration of the example folding jewelry warmer, in the open position.

FIG. 3 shows a flap configuration of the example folding jewelry warmer, in the zippered or closed position.

FIG. 4 shows a flower configuration of the example folding jewelry warmer, in the fully closed position.

FIG. 5 shows a flower configuration of the example folding jewelry warmer, in the partially opened position.

FIG. 6 shows the inside of a flower configuration of the example folding jewelry warmer, in the fully opened position.

FIG. 7 shows the outside of a flower configuration of the example folding jewelry warmer, in the fully opened position.

FIG. 8 is a high level circuit diagram which may be implemented for the example folding jewelry warmer.

### DETAILED DESCRIPTION

A folding jewelry warmer is disclosed herein. In an example, the jewelry warmer is a small device that may be powered to a warming temperature by a USB power supply. USB power supplies are typically already available to most people for their phones and other electronic devices and/or provided with the device. Of course, any suitable AC or DC power supply may be provided, including but not limited to solar and/or battery power.

The device can be made in multiple designs, including one referred to herein as a “flap” design and another referred to herein as a “flower” or “double-flap” design. With both of these exemplary designs, jewelry is placed in the folding jewelry warmer adjacent to (e.g., on top of) a heating element provided under a soft fabric.

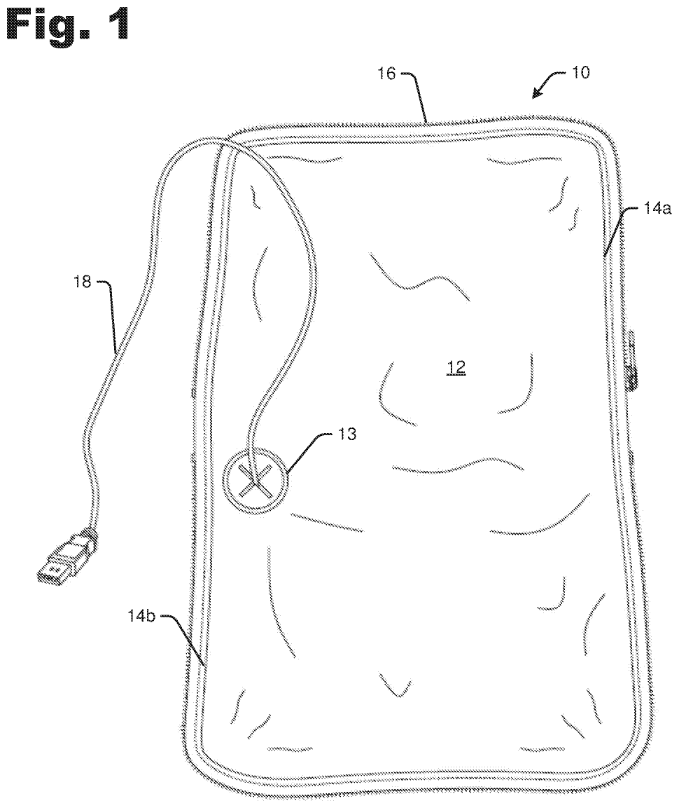

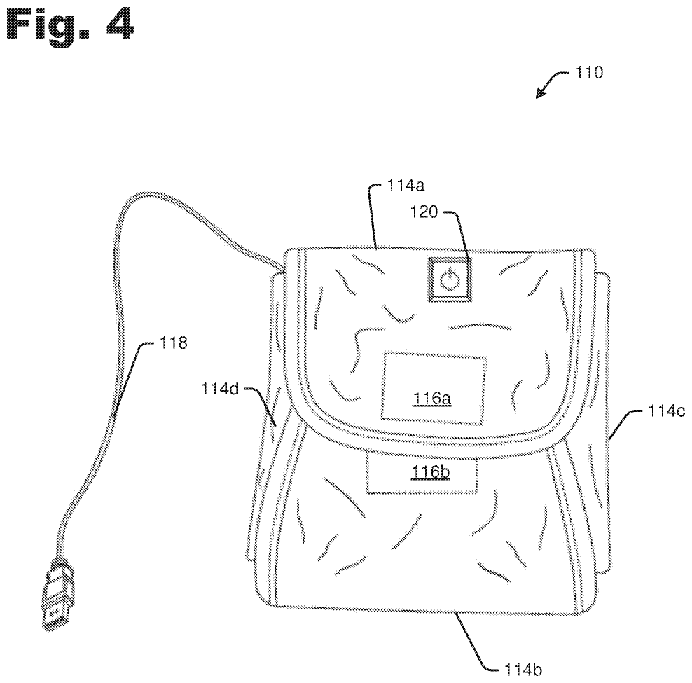

The so-called “flap” design (FIGS. 1-3) has a single zipper that wraps around three sides of the jewelry warmer. When fully unzipped, it can lay completely flat. When fully zipped, it may form a closed, purse-like or substantially rectangular object. The so-called “flower” design (FIGS. 4-7) has two flaps that when fully zipped, also form a closed, purse-like or substantially rectangular object

The jewelry warmer may be implemented to heat or warm jewelry in advance of wearing the jewelry. As such, the jewelry warmer allows the wearer of the jewelry to preheat their jewelry before putting it on to wear the jewelry and avoid feeling the initial, uncomfortable thermal shock from the otherwise cool or even cold jewelry against their skin.

Before continuing, it is noted that as used herein, the terms “includes” and “including” mean, but is not limited to, “includes” or “including” and “includes at least” or “including at least.” The term “based on” means “based on” and “based at least in part on.”

FIG. 1 shows the inside of the so-called “flap” (e.g., a single flap) configuration of the example folding jewelry warmer 10, in an unzipped or open position.

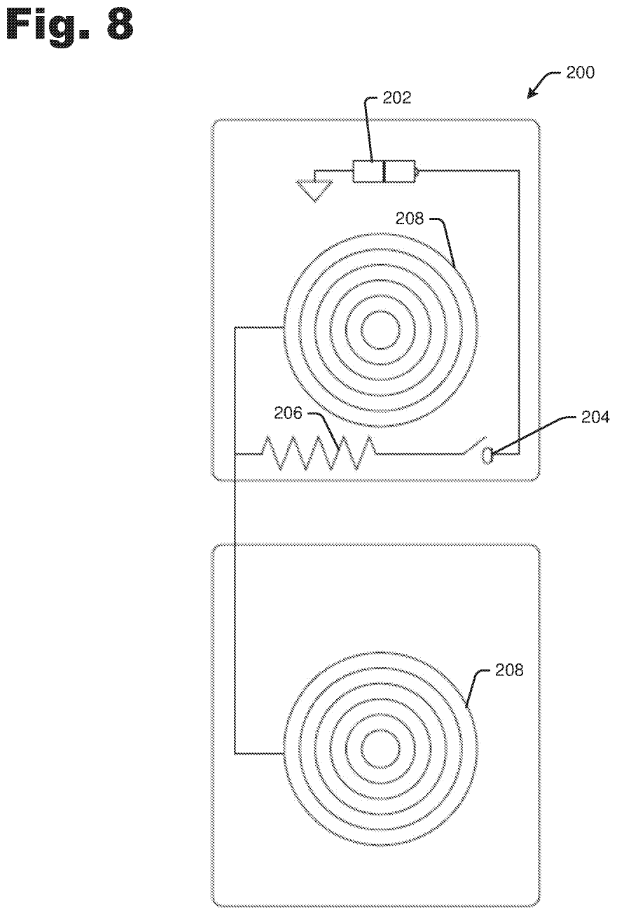

The example device 10 for warming jewelry includes body structure for receiving the jewelry on a first surface 12. At least one flap of the body structure (a single flap is illustrated having two sides 14a and 14b). The flap folds over the jewelry in a closed position, and the flap unfolds from the jewelry in an open position. An electrical heating element (FIG. 8) is provided inside the body structure. The electrical heating element is activated to warm the jewelry within the body structure.

In the example shown in FIG. 1, the body structure has a single flap configuration, and the flap (sides 14a and 14b) fold the body structure substantially in half in this single flap configuration.

In an example, the body structure forms a pouch for receiving the jewelry therein. The pouch (e.g., surface 12) may have a soft fabric (or other suitable soft material) liner for receiving the jewelry.

The flap configuration includes a single layer or flap 12 having opposite sides 14a and 14b, which can be connected to one another by a zipper 16 that wraps around three sides of each side 14a and 14b. When fully unzipped, the jewelry warmer 10 is in an open position and can lay completely flat as shown in FIG. 1. The layer 12 may be made of a soft fabric or other material (e.g., selected to avoid scratching the jewelry). A heating or warming element (see, e.g., FIG. 8) may be provided within the layer 12.

In use, jewelry may be placed in (e.g., approximately in the middle) of the open face of the jewelry warmer 10, on the heating or warming element. Also visible is the power cable 18 which supplies power to the heating or warming element and supporting electronics. In this example, the power cable is a USB (universal serial bus) cable, although as noted above, any suitable power source may be provided. The power cable 18 is provided through an opening 13 formed in the body 12.

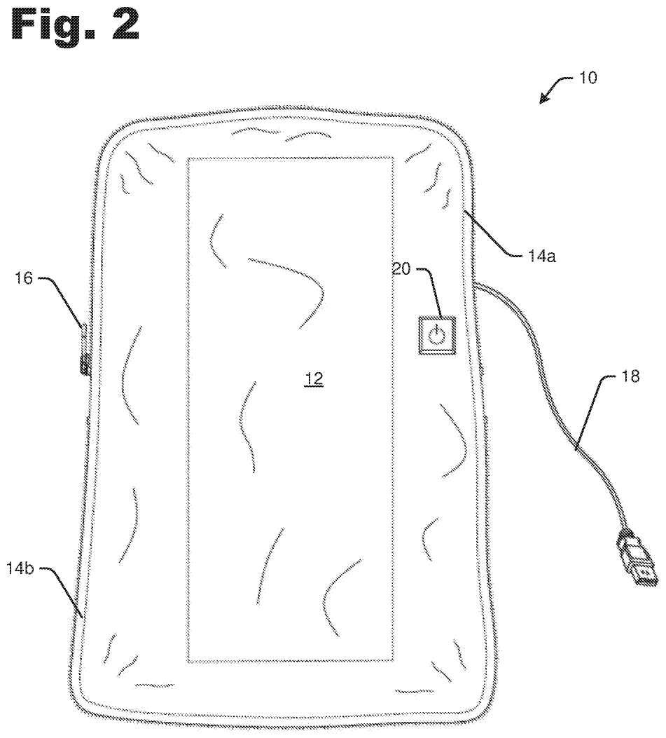

FIG. 2 shows the outside of the so-called flap configuration of the example folding jewelry warmer 10 of FIG. 1, also in the open position. Visible are the zipper 16, power cable 18, and a power button 20 located on the outside surface of the folding jewelry warmer 10. In general, power is not engaged when the folding jewelry warmer is in the open state as shown. In fact, it may be automatically disconnected in an example, e.g., as a safety feature. In another example, the device may be operated in the open position, possibly with reduced or more limited benefit then when operated in the closed position.

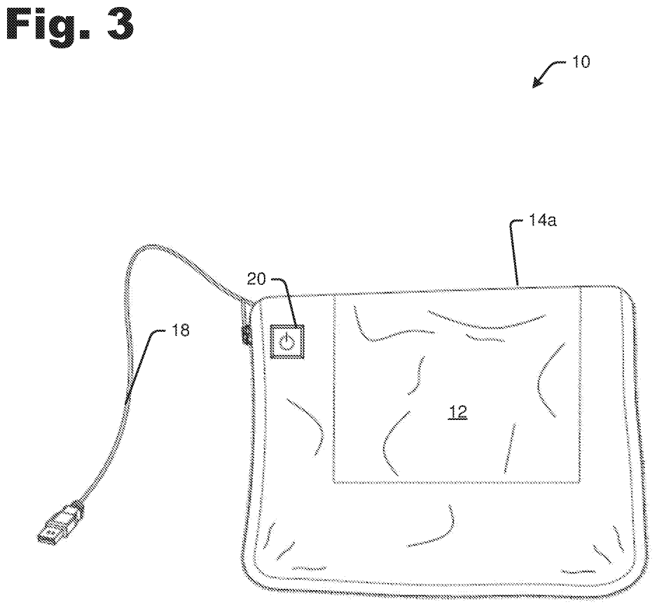

FIG. 3 shows the so-called flap configuration of the example folding jewelry warmer 10 of FIG. 1, in a zippered or closed position. After placing jewelry in the jewelry warmer 10, one side 14a may be folded over the opposite side 14b to enclose the jewelry therein. When fully zipped, it forms a closed, purse-like, substantially rectangular object that may be substantially square, with the jewelry inside. Visible in this view are the zipper 16, power cable 18, and power button 20.

The power button 20 (and/or other control electronics) may allow the user to select from multiple temperatures. The power button 20 may even change color to indicate whether the device is powered or unpowered, and/or which temperature range it is set to (e.g., cool or warm, or display a numeric temperature reading). In an example, the power button 20 allows for three different temperature ranges, and each temperature range has an alternative indicating color (e.g., blue, orange, and red to indicate increasing temperature). Any number of temperature ranges may be implemented. Indeed, the device may operate in a simple on/off (single temperature) mode.

In an example, the device is powered by a USB cable 18, and can be either connected to an AC adapter (sometimes known as a “power brick” or “wall wart”), or connected to an external USB power supply such as a battery. Such a configuration allows for convenient operation even during travel. In an example, the jewelry warmer 10 will automatically shut off after a predetermined period of time to prevent overheating and/or battery drain.

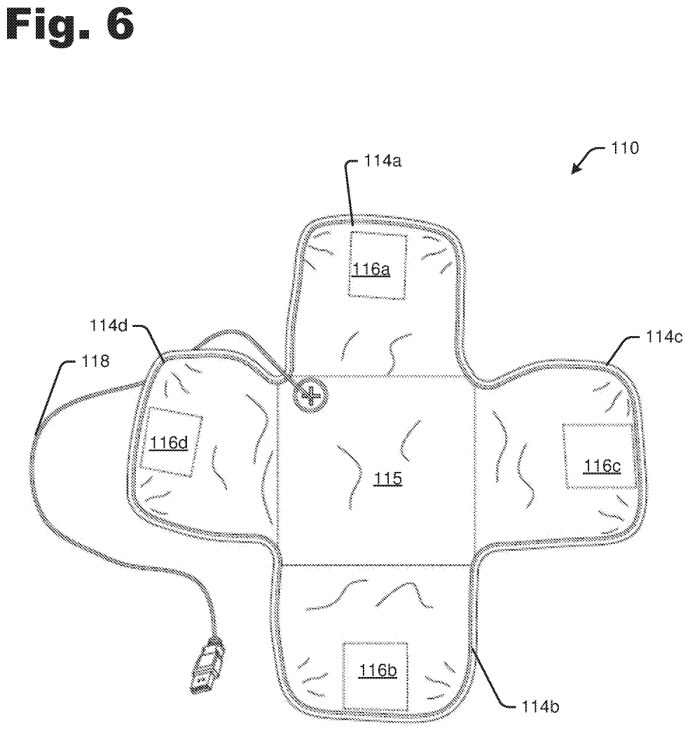

FIG. 4 shows the so-called “flower” configuration of the example folding jewelry warmer 110, in the fully closed position. For the “flower” or double-flap configuration, the device 110 unfolds into the shape somewhat resembling that of a “flower” (e.g., having a center and four petals as illustrated in FIG. 6). The four flaps 114a-d (e.g., “petals”) fold on top of each other over the center 115 to form a substantially square, purse-shaped item when closed, as shown in FIG. 4.

Also visible are the power cord 118 and power button 120, which is placed such that it appears on the exterior of the fully closed device, e.g., on the very top “petal” of the device. Functioning of the power button 120 may be the same as with the flap design of the folding jewelry warmer 10 already described above. In an example, the closures 116a-d are made of Hook-and-Loop or VELCRO™. Other closures, including but not limited to one or more zipper, are also contemplated. In another example, the closures 116a-d are magnetic.

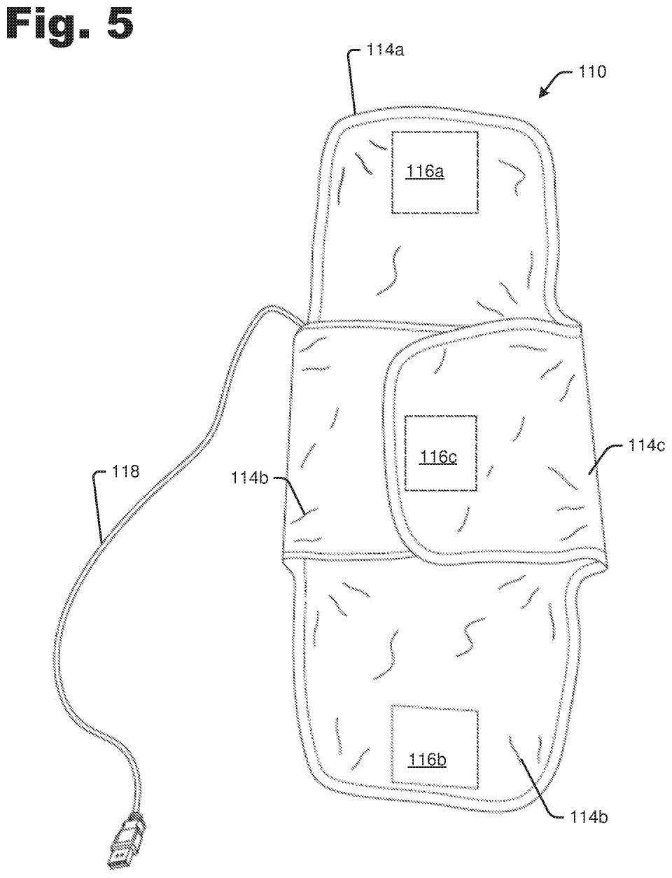

FIG. 5 shows a flower configuration of the example folding jewelry warmer 110 of FIG. 4. In FIG. 5, the folding jewelry warmer 110 is shown in a partially opened position, with flaps 114a and 114b in the unfolded position, and flaps 114c and 114d in the folded or closed position. A first set of closures 116a and 116b has been opened, while a second set of closures 116c and 116d remains engaged.

FIG. 6 shows the inside of the flower configuration of the example folding jewelry warmer 10, in the fully opened position. When fully open, the folding jewelry warmer lays completely flat. Power is also provided via a power cable (e.g., a USB cable), and may be identical to the flap design. In an example, the flower designs is closed by hook and loop closures, as opposed to a zipper in the flap model. In another example, the folding jewelry warmer may include magnetic closures.

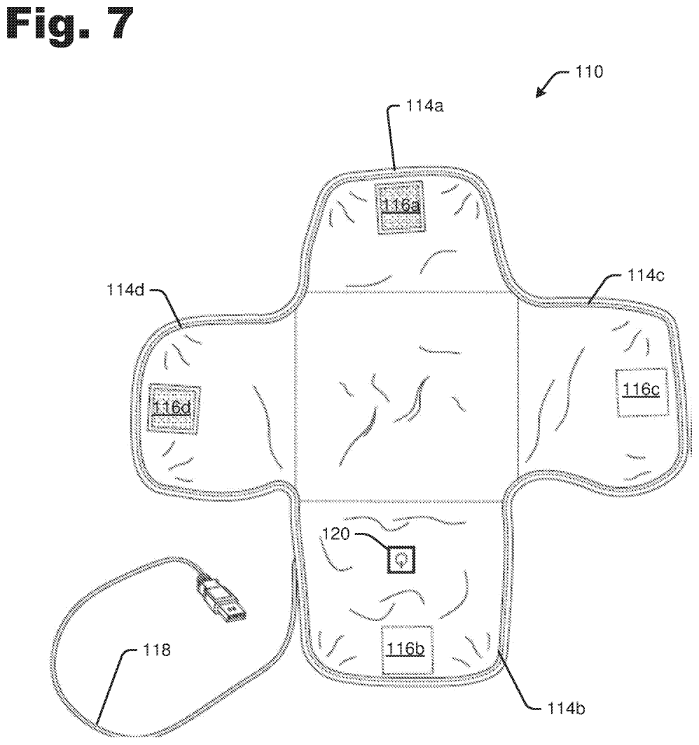

FIG. 7 shows the outer side of the flower configuration of the example folding jewelry warmer 10 in FIG. 6, also in the fully opened position. Visible are the power cord 120 and closures 116a-d. It should be noted that it is possible, as a design choice, to hold the flower design closed with only one set of closures.

The folding jewelry warmer disclosed herein (e.g., device 10 and 110) may be readily portable and packable. For portability, the device lays flat when completely open and is small when closed. It provides a more pleasant experience for the user when donning jewelry that might otherwise be cool or cold and uncomfortable to put on. This may be especially true in winter, or in cold buildings. The device may be powered by either a USB external battery or USB power brick, which makes it convenient for travel. In an example, the device has a power capacity of more than about 2.1 amps, although it is not limited to any particular power requirements.

The operations shown and described herein are provided to illustrate example implementations. It is noted that the operations are not limited to the ordering shown. Still other operations may also be implemented. Temperature ratings may be adjusted. A second heating element may be added to the top of the flap design.

FIG. 8 is a high level circuit diagram of a warming or heating element circuit 200 which may be implemented for the folding jewelry warmer 10 or 110. The circuit 200 may include a power source 202 (e.g., connected via USB cable 18, 118, battery or other source), and a switch 204 (e.g., operated via switch 20, 120). A resistive element 206 may generate heat, which is dissipated via heating coil 208 to provide warmth or heat to jewelry stored in the device 10, 110. In an example, the heating coil 208 may be provided on one side (e.g., in the center of the device, and/or on one or more of the flaps.

The jewelry warming device is described herein for purposes of illustration and is not limited to those examples shown. By way of further illustration, the jewelry warming device may include more flaps, different shape flaps, pockets, advanced electronics (e.g., for control via a mobile app on a phone or other computing device).

It is noted that the examples shown and described are provided for purposes of illustration and are not intended to be limiting. Still other examples are also contemplated.

1. A device for warming jewelry, comprising:
a body structure for receiving the jewelry on a first surface;
at least one flap of the body structure, the flap folding over the jewelry in a closed position, and the flap unfolding from the jewelry in an open position; and
an electrical heating element inside the body structure, the electrical heating element activated to warm the jewelry on the first surface enclosed by the at least one flap within the body structure.

2. The device of claim 1, wherein the body structure has a single flap configuration, the at least one flap folding the body structure substantially in half in the single flap configuration.

3. The device of claim 1, wherein the body structure has a dual flap or “flower” configuration with two or more flaps folding over the jewelry and form the body structure into a substantially rectangular shape in the closed position.

4. The device of claim 1, further comprising at least one closure for the at least one flap.

5. The device of claim 4, wherein the at least one closure is magnetic.

6. The device of claim 4, wherein the at least one closure is a zipper.

7. The device of claim 4, wherein the at least one closure is a hook-and-loop fastener.

8. The device of claim 1, further comprising an actuator to power the electrical heating element on and off.

9. The device of claim 8, wherein the actuator is further configured for selecting among multiple temperature ranges

10. The device of claim 1, further comprising control electronics.

11. The device of claim 10, wherein the control electronics are configured with a timer to automatically turn off the electrical heating element after a predetermined time.

12. The device of claim 10, wherein the control electronics maintain the temperature of the heating element within a selected temperature range.

13. The device of claim 1, wherein the control electronics have a display to indicate a temperature range.

14. The device of claim 1, further comprising a soft fabric liner of the body for receiving the jewelry.

15. A device for warming jewelry, comprising:
a body structure forming a pouch for receiving the jewelry on a soft surface of the body;
at least one flap of the body structure, the flap folding over the jewelry in a closed position of the pouch, and the flap unfolding from the jewelry in an open position of the pouch; and
a heating element inside the body structure, the heating element activated to warm the jewelry on the soft surface within the body structure in the closed position;
wherein when the pouch in the open position lays substantially flat; and
wherein when jewelry is placed within the pouch, the pouch is closed, and the heating element is activated, the jewelry is warmed to a desired temperature.

16. The device of claim 15, wherein the body structure has a single flap configuration, the at least one flap folding the body structure substantially in half in the single flap configuration.

17. The device of claim 15, wherein the body structure has a dual flap or “flower” configuration with two or more flaps folding over the jewelry and form the body structure into a substantially rectangular shape in the closed position.

18. The device of claim 15, further comprising at least one closure for the at least one flap.

19. A device for warming jewelry, comprising:
a body structure;
at least one flap of the body structure, the flap folding over the jewelry in a closed position to form a pouch for the jewelry, and the flap unfolding from the jewelry in an open position of the pouch to add and remove the jewelry;
a heating element inside the body structure, the heating element activated to warm the jewelry within the pouch;
wherein when the pouch in the open position lays substantially flat; and
wherein when jewelry is placed within the pouch, the pouch is closed, and the heating element is activated, the jewelry is warmed to a desired temperature.

20. The device of claim 10, further comprising control electronics to:
automatically turn off the electrical heating element after a predetermined time;
maintain the temperature of the heating element within a selected temperature range; and
indicate the selected temperature range.
